(19) United States
(12) Patent Application Publication
(10) Pub. No.: US 2013/0154441 A1
(43) Pub. Date: Jun. 20, 2013

(54) FLOORING SYSTEM AND FLOOR TILE

(71) Applicant: Elizabeth Redmond, Dexter, MI (US)

(72) Inventor: Elizabeth Redmond, Dexter, MI (US)

(21) Appl. No.: 13/593,357

(22) Filed: Aug. 23, 2012

Related U.S. Application Data
(60) Provisional application No. 61/526,409, filed on Aug. 23, 2011.

(51) Int. Cl. H02N 2/18; G06K 19/067

(52) U.S. Cl. CPC H02N 2/181; G06K 19/067
USPC 310/319; 235/492

(57) ABSTRACT

One variation of a preferred flooring system includes: a first energy device configured for arrangement under a footpath, the first energy device outputting a first current in response to a force applied to the footpath; a second energy device configured for arrangement under the footpath adjacent the first energy device, the second energy device outputting a second current in response to a force applied to the footpath; a wireless transmitter; and a network that communicates the first and second currents from the first and second energy devices to the wireless transmitter; wherein the wireless transmitter is powered by the first current to transmit a data packet associated with a force applied to the footpath.

### CROSS-REFERENCE TO RELATED APPLICATIONS

This application claims the benefit of U.S. Provisional Patent Application No. 61/526,409, filed 23 Aug. 2011 and which is incorporated in its entirety herein by this reference.

### TECHNICAL FIELD

This invention relates generally to the field of traffic monitoring, and more specifically to a new and useful flooring system and floor tile in the field of traffic monitoring.

### BACKGROUND

Pedestrian- and vehicle-related traffic sensors can provide great insight into walkway, building, and road usage. However, systems that track pedestrian and vehicle usage of ground, road, and floor surfaces typically have external power requirements and are therefore difficult to install for both new and renovated structures. Thus, there is a need in the field of traffic monitoring to create a new and useful flooring system and floor tile. This invention provides such new and useful systems and methods.

### BRIEF DESCRIPTION OF THE FIGURES

FIG. 1 is a schematic representation of a flooring system of a first preferred embodiment;

FIG. 2 is a schematic representation of one variation of the preferred flooring system 100;

FIG. 3 is a schematic representation of one variation of the preferred flooring system 100;

FIG. 4 is a schematic representation of one variation of the preferred flooring system 100;

FIG. 5 is a schematic representation of one variation of a floor tile of a second preferred embodiment; and

FIG. 6 is a schematic representation of one variation of the preferred flooring system.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Preferred Flooring System

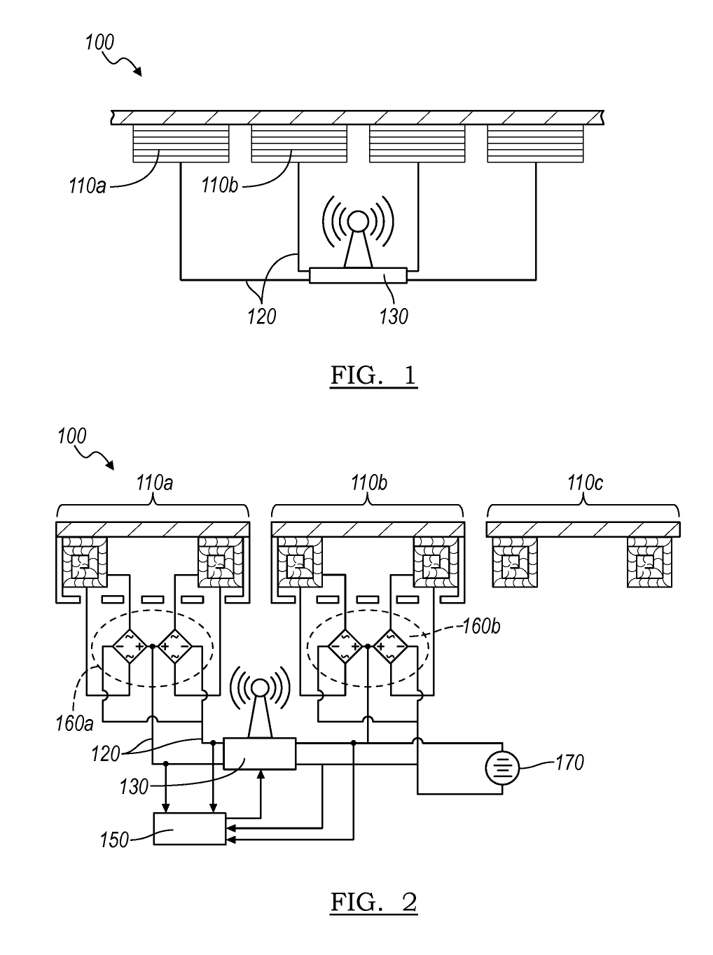

As shown in FIG. 1, a flooring system 100 of a preferred embodiment includes a first energy device 110b, a second energy device 110b, a wireless transmitter 130, and a network 120. The first energy device 110a is configured for arrangement under a footpath and outputs a first current in response to a force applied to the footpath. The second energy device 110b is configured for arrangement under the footpath adjacent the first energy device 110a and outputs a second current in response to a force applied to the footpath. The network 120 communicates the first and second currents from the first and second energy devices 110a, 110b to the wireless transmitter 130. The wireless transmitter 130 is powered by at least one of the first and second currents to transmit a data packet associated with a force applied to the footpath.

The preferred flooring system 100 is preferably a standalone floor sensor system that harvests energy from forces applied to the flooring surface and uses the harvested energy to power wireless transmission of data related to the forces applied to the flooring surface. Generally, the preferred flooring system 100 preferably implements the energy devices 110a, 110b to harvest energy from persons, vehicles, machinery, or other objects in motion over the flooring surface, wherein the network 120 distributes the energy to power the wireless transmitter 130, and wherein the wireless transmitter 130 communicates signals from the energy devices 110a, 110b to an external wireless receiver. The preferred flooring system 100 is preferably an independently-powered, standalone flooring system that is disconnected from any external electrical or chemical power source and instead harvests energy from mechanical vibrations, forces, strains, pressures, impacts, etc. applied to the flooring surface (e.g., by humans or animals walking across the flooring surface or machinery or vehicles rolling across the flooring surface) to power the wireless transmitter 130 and any other electronic device or circuitry within or connected to the preferred flooring system 100. Furthermore, the energy devices 110a, 110b of the preferred flooring system 100 preferably double as sensors that detect a person, animal, machine, vehicle, or other object moving across the flooring surface. Therefore, the preferred flooring system 100 is preferably a self-contained, self-powered sensor system that collects and wirelessly transmits pedestrian and/or vehicle traffic data substantially in real time.

The first energy device 110a of the preferred flooring system 100 is configured for arrangement under a footpath and outputs a first current and a first sensor signal in response to a force applied to the footpath. The second energy device 110b of the preferred flooring system 100 is configured for arrangement under the footpath adjacent the first energy device 110a and outputs a second current in response to a force applied to the footpath. Generally, a force applied to the footpath adjacent the first energy device 110a preferably deforms the first energy device 110a, which induces a voltage potential across a portion thereof. Furthermore, a force applied to the footpath adjacent the second energy device 110b preferably deforms the second energy device 110b, which induces a voltage potential across a portion thereof.

The first and second energy devices 110a, 110b (‘energy devices’) are preferably arranged beneath the flooring surface and can further function to support a portion of the flooring surface such that the portion of the flooring surface floats over the first and second energy devices 110a, 110b. In one example implementation, the first and second energy devices 110a, 110b are arranged in sheet-like housings placed under a carpet that defines a flooring surface within a room inside a building. In another example implementation, the first and second energy devices 110a, 110b support a wood parquet flooring surface within a room or hall inside a building. In a further example implementation, as shown in FIG. 6, the first and second energy device, as well as two additional energy devices, support each corner of a (rigid) square floor tile, wherein the wireless transmitter 130 is cooperatively powered by the first, second, and additional energy devices via the network 120 that electrically couples the first, second, and additional energy devices to the wireless transmitter 130. In this example implementation, the first, second, and additional energy devices can be paired with a single floor tile or each energy device 110 can support the corners of (three) adjacent floor tiles. In still another example implementation, the first and second energy devices 110a, 110b support an overhead floating cast concrete sidewalk slab. In a further example implementation, as shown in FIG. 4, the first energy device 110a is arranged in a first access floor pedestal and the second energy device 110b is arranged within a second access floor pedestal, wherein the first and second access floor pedestals support the flooring surface overhead.

Alternatively, the first and second energy devices 110a, 110b can be integrated into a building flooring material. In one example implementation, the first and second energy devices 110a, 110b are incorporated into a rubberized floor covering that is unrolled, trimmed, and glued to a subfloor. In another example implementation, the first and second energy devices 110a, 110b are arranged in rectilinear housings or ‘tiles’ that can be patterned across a walkway, wherein each housing includes an outer textured, non-slip surface that defines the flooring surface. In this implementation, the tiles can include interlocking features that couple one housing to an adjacent housing. Furthermore, in this example implementation, a set of tiles can define a portion of the network 120, wherein one tile communicates current, output by an adjacent tile, to the wireless transmitter 130. However, the first and second energy devices 110a, 110b can be arranged and implemented in any other way.

The first and second energy devices 110a, 110b preferably convert mechanical energy applied to the flooring surface into electrical energy. Generally, a flooring surface preferably transmits an applied force into an adjacent energy device that generates a voltage differential when deformed. The voltage potential created by each energy device 110 when deformed preferably induces an electrical current to flow through the energy device 110 and out to the network 120.

Each energy device 110 preferably includes at least one polarized polyvinylidene fluoride (PVDF) piezoelectric layer sandwiched between a set of electrodes or conductive sheets that communicate current into and/or out of the piezoelectric layer. In one example implementation, as shown in FIG. 1, each energy device 110 includes multiple stacked piezoelectric layers separated by (shared) electrodes. In another example implementation, as shown in FIG. 2, the piezoelectric layer is wound with the conductive layer to create an effective piezoelectric stack of a single continuous piezoelectric layer or film. In a further example implementation, the foregoing example implementations are combined to form a wound piezoelectric stack of multiple piezoelectric layers. In these example implementations, the electrode can be a metallic (e.g., copper, aluminum) foil, a conductive ink, or any other suitable material. The electrodes preferably include leads that couple to the network 120 to communicate the current out of an each energy device 110. In one example, a housing includes conductive traces that align with a pair of electrodes from each of the first, the second, and two additional energy devices, wherein each energy device supports a corner of a square floor tile. In this example, the housing preferably further includes the wireless transmitter 130, a rectifier 160, and locating features (e.g., clips, fasteners, or potting) that secure the energy devices to the housing.

However, each energy device 110 can alternatively include one or more lead zirconate titanate (PZT) piezoelectric layers arranged in similar wound and/or stacked configurations, a pressure vessel coupled to a fluid-driven generator, a coil moving relative a magnetic element, a connecting rod eccentrically driving a generator, or any other suitable electromechanical energy harvester or generator. Furthermore, each energy device 110 can include multiple energy harvesters or generators with outputs coupled in parallel or in series, such as a stack of PVDF piezoelectric layers. However, each energy device 110 can include any other type and/or number of energy harvesters or generators, can be of any other form, or can function in any other way.

Deformation of each energy device 110 is preferably in the form of a compression and decompression cycle, or a ‘strain cycle,’ of the energy device 110. Generally, compression of the energy device 110 preferably induces current flow in a first direction (e.g., net flow out of the energy device 110), and decompression of the energy device 110, which occurs when the energy device 110 is unloaded, preferably induces current flow in a second direction opposite the first direction (e.g., net flow into the energy device 110). Therefore and as shown in FIG. 2, each energy device 110 preferably includes or is coupled to a rectifier 160 that directs positive and negative charge gradients of a strain cycle of the energy device 110 to maintain current flow in a single direction in response to deformation of the energy device 110 (i.e. in response to an applied force). The rectifier 160 preferably converts the alternating current from an energy device 110 into a direct current (i.e. with current flowing in a single direction through the energy device 110). In one example implementation, the first energy device 110a includes a PVDF piezoelectric layer coupled to the rectifier 160 that includes a diode bridge. In another example implementation, the rectifier 160 includes a diode on each side of the piezoelectric layer, wherein the diodes restrict current flow through the piezoelectric layer to a single direction. Each energy device 110 can be paired with a single accompanying rectifier, or a single rectifier can service multiple energy devices, such as via the network 120. Alternatively, the network 120 or wireless transmitter can include the rectifier 160, wherein alternating current from each energy device 110 is transmitted through all or a portion of the network 120 before being converted into direct current by the rectifier 160. However, the rectifier 160 can be of any other form, function in any other way, and be coupled in any other component or in any other quantity within the preferred flooring system 100.

Each energy device 110 is preferably arranged under the flooring surface and/or within a floor tile such that the energy device 110 deforms in either a compression mode or a bending mode in the presence of a force applied to the flooring surface. However, each energy device can deform in any other suitable more, such as a tension mode or a torsion mode in the presence of an applied force.

Deformation of each energy device 110 is preferably limited to linear vertical displacement, wherein a person walking, an animal walking, or a machine or implement rolling or sliding across the flooring surface applies a force that vertically displaces a section of the flooring surface and compresses the energy device 110 adjacent the displaced section of the flooring surface. Displacement of the flooring surface preferably does not substantially impede motion of the person, animal, or machine moving across the flooring surface. Total vertical travel of the flooring surface over each energy device 110 is therefore preferably limited to less than 1 mm, though travel of the preferred flooring system 100 can be of any other value or magnitude. Total vertical travel of the flooring surface over each energy device 110 can also be tailored for specific applications. In a first example, the preferred flooring system 100 is implemented in a lobby of a large commercial building, wherein total travel of the flooring surface over the energy device 110 is 0.5 mm for every 50 kg of loading within a 1 m² energy device area with a maximum displacement of 3 mm. In another example implementation, the preferred flooring system 100 is implemented beneath a highly trafficked sidewalk, wherein a total travel of the flooring surface over the energy device 110 is 0.5 mm for every 100 kg load within a 1 m² energy device area with a maximum displacement of 8 mm. In a further example implementation, the preferred flooring system 100 is implemented beneath a flooring surface that is a road surface, wherein a total travel of the road surface over the energy device 110 is 1 mm for every 500 kg load within a 1 m² energy device area with a maximum displacement of 10 mm. When implemented adjacent a flooring surface designated for pedestrian traffic, displacement of the energy devices is preferably limited to compression distances of typical flooring surfaces or floor coverings, such as 2 mm for a medium-loft rug or 1 mm for a parquet wood floor. However, compression and displacement characteristics of the energy device 110 and the flooring surface can be customized in any other way and for any other application.

Each energy device 110 preferably includes an electromechanical compressible layer, such as a PVFD piezoelectric layer, that is elastically compressible over the total displaceable distance of the flooring surface and/or the total anticipated compression of the energy device 110. Generally, each energy device 110 preferably defines a linear or nonlinear spring constant such that the energy device 110 will return to an unloaded or ‘rest’ position when the flooring surface adjacent the energy device no is unloaded. Total displacement of the flooring surface and/or each energy device no can therefore be modified by adjusting the number of electromechanical compressible layers within each energy device 110. The spring constant of each energy device 110 can also be modified by selecting one or more electromechanical compressible layers with specific spring constants or by stacking multiple electromechanical compressible layers of different spring constants. Each energy device 110 can additionally or alternatively include mechanical, hydraulic, pneumatic, or any other type of spring that returns the energy device 110 to an unloaded position when the applied force is released. However, each energy device 110 can include any other type or number of layers or components that cooperate to return the compressed energy device to the unloaded or rest position when the force is removed from the flooring surface adjacent the energy device 110.

In one variation of the preferred flooring system 100, the current output by each energy device 110 and which powers the wireless transmitter 130 is also a sensor signal. In one implementation, the combined sensor signal and current, output from the first energy device 110a in response to an applied force on the flooring surface, powers the wireless transmitter and triggers the wireless transmitter to transmit a data packet indicating that the first energy device 110a was deformed by an applied force. The data packet preferably includes a unique identifier for the deformed energy device 110, the floor tile that includes the energy device 110, or other portion of the preferred flooring system 100, such as a serial number or user-defined identifier of the energy device 110, floor tile, or flooring system 100. Alternatively, a processor coupled to an energy device no intercepts a current output by the energy device 110 and outputs to the wireless transmitter a signal associate with an object moving across the flooring surface. The signal can include any the weight, mass, speed, direction, velocity, time, or other relevant metric of motion of the object that extracted from the current output by the energy device 110 in response to an applied force. In this example implementation, the data packet transmitted by the wireless transmitter preferably includes a form of one or more of the foregoing extracted metrics.

In another example implementation of this variation of the preferred flooring system 100, the wireless transmitter 130, the processor 150, or any other active or passive component or circuitry within the preferred flooring system 100 accesses a current from an energy device and associates the current with a type of an object moving across the flooring surface, such as a human or a four-wheeled vehicle. Furthermore, any of the wireless transmitter 130, the processor 150, or any other active or passive component or circuitry can identify additional characteristics of the current based upon the magnitude and/or timing of the current. For example, a current with a high peak amplitude can be associated with a heavy object, such as a passenger vehicle, moving over the flooring surface proximal the energy device 110, whereas a current with a low peak amplitude can be associated with a lighter object, such as a healthy human, moving over the flooring surface proximal the energy device 110. In another example, a current output from the energy device 110 and including several peaks and troughs repeated at a frequency between 0.8 Hz and 1.25 Hz is associated with a human walking across the flooring surface proximal the energy device 110, whereas a current output from the energy device 110 and including several peaks and troughs repeated at a frequency between 0.5 Hz and 1.8 Hz is associated with a human running across the flooring surface proximal the energy device 110. Similarly, a current output from the energy device 110 and including a slow ramp up to and a slow return from a peak magnitude can be associated with a wheeled vehicle (e.g., a car, a bicycle, a cart) moving slowly across the flooring surface proximal the energy device 110, whereas a current output from the energy device 110 and including a fast ramp up to and a quick return from a high peak magnitude is associated with a wheeled vehicle moving at a high rate of speed across the flooring surface proximal the energy device 110. In a further example, the direction, speed, or velocity of a person, animal, machine, etc. moving across the flooring surface can be estimated by comparing output currents from multiple energy devices. For example when the distance between and locations of the first and the second energy devices 110a, 110b are known, the timing and order of impacts on the flooring surface adjacent the first and second energy devices 110a, 110b can indicate velocity of motion across the flooring surface, wherein motion is determined to be in a first direction when the impact adjacent the first energy device 110a occurs before the impact adjacent the second energy device 110b, wherein motion is determined to be in a second direction when the impact adjacent the second energy device 110b occurs before the impact adjacent the first energy device 110a, and wherein the speed of motion is estimated by dividing the known distance between the first and second energy devices 110a, 110b by the time between peak current amplitudes at the first and second energy devices 110a, 110b. Furthermore, currents output by additional energy devices adjacent the first and second energy devices 110a, 110b can be compared against output currents from the first and second energy devices 110a, 110b to improve the resolution of the direction, speed, or velocity estimation of the object moving across the flooring surface proximal the energy devices 110a, 110b.

A raw voltage or current signal output by an energy device 110 in response to the object moving across flooring surface is preferably read before the signal passes through the rectifier and/or other conditioning electronics within the preferred flooring system 100. In one example implementation, signal information is interpreted at the wireless transmitter 130 and transmitted in a data packet. In another example implementation, raw signal information is transmitted directly by the wireless transmitter 130 and interpreted by the external wireless receiver or by a central server.

In another variation of the preferred flooring system 100, each energy device 110 outputs a sensor signal that is distinct from the current. In this variation, the sensor signal is preferably a low-current digital signal. In one example implementation, each energy device 110 sets an output pin to a first state (e.g., LO) when unloaded and to a second state (e.g., HI) when loaded by an object moving across the flooring surface proximal the energy device 110. A processor, an operational amplifier (e.g., comparator), a zener diode, or any other active or passive circuitry within the preferred flooring system 100 can compare the magnitude of a force applied to an energy device 110 with a threshold force, wherein the applied force that exceeds the threshold force preferably triggers a state change of the output pin of the energy device 110. In another example implementation, each energy device 110 includes an analog-to-digital (AD) converter that converts an analog current output by the energy device 110 into a low-current digital signal representing the magnitude of the current output in the form of set digital bits. In this variation, the digital bits can be transmitted from each energy device 110 (e.g., to the wireless transmitter 130, to a processor) via master-slave, one-wire, I2C, or any other suitable communication protocol. Furthermore, the digital bits representing the magnitude of current output by an energy device (correlated with magnitude of applied force) can be distributed throughout the preferred flooring system 100 when the magnitude of the current output is greater than a threshold magnitude or when a change in current output occurs in more or less time than a threshold time. In this variation of the preferred flooring system 100, each energy device 110 can also include a short-range wireless module that communicates a digital form of the current output signal to the wireless transmitter 130. In this example implementation, the sensor signal can be analyzed as described above to calculate the weight, mass, speed, direction, velocity, time, etc. of the force applied to the flooring surface, and any of this data can be distributed to and transmitted by the wireless transmitter 130. However, each energy device 110 can output any other form or type of signal in response to a force applied to the flooring surface proximal the energy device 110.

The network 120 of the preferred flooring system 100 communicates the first and second currents from the first and second energy devices 110a, 110b to the wireless transmitter 130. In the variation of the preferred flooring system 100 in which the sensor signal is distinct from the current, the network 120 can also communicate sensor signals to the wireless transmitter 130. Additionally or alternatively, the network 120 can communicate energy device outputs (e.g., sensor signals, current) to the processor 150 that analyzes or otherwise manipulates the energy device 110 outputs. The network 120 can further communicate an output of the processor 150 to the wireless transmitter 130.

In one example implementation, the network 120 includes a series of wire leads that electrically couple the first and second energy devices 110a, 110b, in parallel or in series, to the wireless transmitter 130. In another example implementation, the network 120 includes printed traces on a floor backing material (or subfloor mat), wherein the first and second energy devices 110a, 110b are arranged over and located by the floor backing material, and wherein the printed traces electrically couple to the first and second energy devices 110a, 110b to communicate the outputs thereof to the wireless transmitter 130. In a further example implementation, the preferred flooring system 100 includes additional energy devices, wherein the first, second, and additional energy devices (e.g., 23+ additional energy devices) physically couple to form an interlocking flooring system, and wherein the additional energy devices function as the network 120 to communicate outputs of the first and second energy devices 110a, 110b to the wireless transmitter 130. However, the network 120 can be of any other form or defined in whole or in part by any other component.

The network 120 preferably electrically couples the first and second energy devices 110a, 110b to the wireless transmitter 130. The network 120 can separately couple each energy device 110 to the wireless transmitter 130 (or processor or other active or passive circuit within the preferred flooring system 100) such that the wireless transmitter 130 receives distinct outputs from each energy device. Alternatively, network 120 can electrically couple all or a set of the energy devices 110a, 110b within the preferred flooring system 100 in parallel or in series. For example, the first and second energy devices 110a, 110b can cooperate with two additional energy devices to support each corner of a square floor tile, and the network 120 can electrically couple the four energy devices in series such that voltage differentials across each of the four energy devices sum to output a higher voltage when multiple forces are applied to the flooring surface adjacent multiple energy devices. Similarly, the network 120 can electrically couple, in parallel, the energy devices 110a, 110b supporting the floor tile and energy devices supporting similar adjacent floor tiles such that currents output by the energy devices across multiple floor tiles sum to provide a greater current without substantially increased voltage when multiple forces are applied to the flooring surface adjacent multiple energy devices. Generally, the network 120 preferably couples multiple energy devices in parallel and/or in series to tailor the preferred flooring system for a particular current and/or voltage output in the presence of one or more applied forces of typical or expected magnitudes.

In one example implementation, the network 120 electrically couples the energy devices to output a minimum voltage in the presence of at least one 150 lb. force applied to the flooring surface, such as a 3.1 V (e.g., minimum wireless transmitter operating voltage). Furthermore, the network 120 can electrically couple the energy devices to output a maximum voltage in the presence of a peak expected force applied to the flooring surface, such as a 13V (e.g., peak ideal input voltage into a voltage regulator that feeds the wireless transmitter 130). Alternatively, the network 120 can electrically couple the energy devices to output a minimum current in the presence of at least one 150 lb. force applied to the flooring surface, such as a 100 mA (e.g., minimum wireless transmitter operating current).

The network 120 can alternatively couple the first energy device 110a to the wireless transmitter 130, the second energy device 110b to a second wireless transmitter, and additional energy devices to additional wireless transmitters. However, the network 120 can electrically couple the first, second, and any additional energy devices in any other way, and the network 120 can be of any other form or communicate the outputs of the energy devices to any one or more wireless transmitters in any other way.

The wireless transmitter 130 of the preferred flooring system 100 is powered by the first current to transmit a data packet associated with a force applied to the footpath. The first energy device 110a preferably deforms in the presence of the applied force to output the first current that powers the wireless transmitter 130. The wireless transmitter 130 can be further powered by the second current from the second energy device 110b to transmit a data packet associated with a force applied to the footpath. The second energy device 110b preferably deforms in the presence of the applied force to output the second current that powers the wireless transmitter 130. The data packet transmitted in response to the first current preferably includes a unique identifier that identifies the first energy device 110a. For the second energy device 110b that is arranged within a housing shared with the first energy device 110a, the wireless transmitter 130 can transmit an identical identifier for the second current. However, for the second energy device 110b that is substantially distinct from the first energy device 100a or arranged in a separate housing from the first energy device 110a, the wireless transmitter 130 can transmit a second unique identifier for the second current. However, the wireless transmitter 130 can be further powered by currents from other energy devices to transmit a data packet associated with other forces applied to the footpath, and the wireless transmitter can transmit a unique identifier for each or a set of currents received from each energy device 110.

In one example implementation, the wireless transmitter 130 is contained in a housing separate from one or more housings that contain the energy devices 110a, 110b, and the wireless transmitter 130 is electrically coupled to the energy devices 110a, 110b via the network 120 that includes a series of (current-carrying) cables or wires. In another example implementation, the wireless transmitter 130 is contained within a master housing that also includes the first energy device 110a, wherein the master housing is electrically coupled to secondary housings that contain additional energy devices, wherein the wireless transmitter 130 in the master housing is powered by and transmits data packets in response to currents received from the energy devices in the master housing and in the secondary housings. In yet another example implementation, each energy device 110 or a set of energy devices is/are arranged within one housing that also includes one wireless transmitter. In this example implementation, the energy device(s) in each housing can further communicate currents to an adjacent housing to power a wireless transmitter in the adjacent housing.

The wireless transmitter 130 is preferably a short-range, low-power wireless device that can transition between a non-powered state (e.g., no input current, an OFF state) and a powered state (i.e. an ON state) when at least one energy device 110 outputs a current in response to a force applied to the flooring surface. The wireless transmitter 130 preferably transmits the data packet during a powered or ON state. For example and as described above, the wireless transmitter 130 can transmit a trigger signal indicating the occurrence of a force applied to the flooring surface. Alternatively and as described above, the wireless transmitter 130 can transmit a unique identifier for one or a set of energy devices. Furthermore, the wireless transmitter 130 can transmit a data-rich signal that indicates any one or more of the weight, mass, location, direction, speed, velocity, time, count, etc. of one or more objects applying one or more forces to the flooring surface adjacent one or more the energy devices. When multiple forces are applied to the flooring surface adjacent multiple energy devices substantially simultaneously, the wireless transmitter 130 can briefly store triggers for each received current to enable succeeding transmissions of similar or unique data packets for each received current. Alternatively, the wireless transmitter 130 can aggregate currents from multiple energy devices into an aggregate data packet, wherein the aggregate data packet can include one or more unique identifiers for one or a set of energy devices.

The wireless transmitter 130 can further transmit longer-term data, such as trends in magnitude, timing, direction, speed, velocity, etc. of forces applied to the flooring surface. However, the wireless transmitter 130 can transmit any other sensor-related data of any other form or content. The wireless transmitter 130 can further transmit system-related data, such as the functionality of each connected energy device, errors or malfunctions, settings, serial number, system location, installation date, etc. However, the wireless transmitter 130 can transmit any other suitable system-related data or information.

The wireless transmitter 130 is preferably a low power, low-range wireless transmitter, such as Bluetooth, ZigBee, XBee, Nordic, WiFi, EnOcean, RFID, or other suitable wireless transmitter. The wireless transmitter 130 preferably requires a substantially minimal initiation time such that the wireless transmitter 130 can remain dormant or effectively OFF until a force applied to the flooring surface adjacent an energy device 110 induces a current that powers the wireless transmitter 130. However, the wireless transmitter 130 can be of any other form and include any other suitable feature.

The wireless transmitter 130 can further include a power signal conditioning circuit that conditions and/or converts currents from one or more energy devices into an acceptable format to power the wireless transmitter 130. For example, the power signal conditioning circuit can include a voltage regulator and a capacitor, wherein the regulator limits the peak voltage supplied to the wireless transmitter 130, and wherein the capacitor stores excess current to protect the wireless transmitter 130 from over-currents. The power signal conditioning circuit can additionally or alternatively include a band pass filter (or other type of filter) that removes low- and high-frequency disturbances in currents output from one or more energy devices. The power signal conditioning circuit can additionally include a comparator circuit that compares a current or voltage output from an energy device 110 against a set threshold current or voltage, wherein the comparator circuit triggers the wireless transmitter 130 to send data when an output current or voltage is greater than (or less than) the threshold current or voltage. However, the power signal conditioning circuit can include any other suitable active or passive component to condition currents from one or more energy devices to power the wireless transmitter 130. Furthermore, other components of the preferred flooring system 100, such as a processor, can include a similar power signal conditioning circuit, though the power signal conditioning circuit can alternatively be included in any other component of the preferred flooring system 100.

In one variation of the preferred flooring system 100, the wireless transmitter 130 is a portion of a wireless transceiver including a wireless receiver that receives a wireless signal from an external source. The preferred flooring system 100 can modify internal settings based upon the received signal, such as threshold force levels, overrides, a daily armed and disarmed schedule, or any other system setting. Alternatively, data received by the wireless receiver can trigger the wireless transmitter 130 to transmit certain data, such as trend in forces applied to the flooring surface. However, the wireless receiver can receive any other signal, and the preferred flooring system 100 can implement the received signal in any other way.

As shown in FIG. 2, the preferred flooring system 100 can further include a processor 150 that is coupled to the wireless transmitter 130, is powered by the first current, and extracts a first sensor signal from the first current. The processor 150 is preferably coupled to multiple energy devices and independently analyzes the outputs of each. In one example implementation, a first set of energy devices arranged beneath a first portion of a flooring surface is paired with a first processor, and a second set of energy devices arranged beneath a second portion of the flooring surface is paired with a second processor. Alternatively, a single processor can be coupled to all energy devices in the preferred flooring surface, coupled to a single energy device, and/or arranged within a single floor tile including one or more energy devices. However, the processor 150 can be arranged within the preferred flooring system 100 in any other way.

The processor 150 is preferably interposed between the wireless transmitter 130 and at least one energy device 110, wherein the current or voltage output of the energy device 110 is communicated to the processor 150, and the processor 150 preferably subsequently transmits a form of the current and/or voltage to the wireless transmitter 130 for transmission. The processor 150 preferably siphons enough power from the energy device output current to power itself, wherein a remainder of the current is directed to the wireless transmitter 130 and/or to an energy storage module (e.g., a rechargeable battery, a capacitor).

As described above, the processor 150 can analyze the current from at least one energy device to estimate the magnitude of a force or impact on the flooring surface proximal the energy device 110. For example, the processor 150 can include an analog-to-digital converter that converts an analog current into a digital sensor signal, wherein the processor 150 extracts, from the digital sensor signal, a peak force and time of peak force applied to the flooring surface. Alternatively, the processor 150 can include an analog-to-digital converter that similarly converts an analog voltage across a portion of an energy device 110 into a digital sensor signal. The processor 150 can then extrapolate the weight, mass, motion or gait characteristic (e.g., rolling, walking, running), or other force or impact-related data of an object that applies a force to the flooring surface. The processor 150 can additionally or alternatively incorporate a time element to extrapolate the speed, direction, velocity, or other motion characteristic of the object by comparing the outputs of two or more (e.g., the first and second) energy devices.

The processor 150 can further track force applications over time. For example, the processor 150 can track the number of instances that forces applied to one energy device exceed a threshold force within a defined time window. The processor 150 can additionally or alternatively output a graphical representation of force applications to the flooring surface adjacent one or more energy devices over time. The processor 150 can similarly output a graphical representation of object motion across the flooring surface proximal two or more energy devices. The processor 150 can additionally or alternatively output data related to extrapolated object types (e.g., running human, walking human, car, cart, wheelchair) moving across the flooring surface. However, the processor 150 can extract or extrapolate any other data related to one or more outputs of one or more energy devices at a single instance or over a period of time. The processor 150 can further communicate any or all of this data to the wireless transmitter 130 for transmission.

As shown in FIG. 2, another variation of the preferred flooring system 100 includes an energy storage module 170 electrically coupled to the first and second energy devices 110a, 110b, wherein the energy storage module 170 stores energy (i.e. current) harvested by the first and second energy devices 110a, 110b. The energy storage module 170 is preferably a rechargeable energy storage module that stores energy when excess energy is harvested by one or more energy devices. The energy storage module 170 preferably further releases or discharges energy when the energy devices 110a, 110b are not supplying sufficient power to the wireless transmitter 130 to enable completion of data transmission. The energy storage module 170 therefore preferably stored power during period of excess current from the energy devices 110a, 110b to power the wireless transmitter 130 over a longer period with a more consistent supplied current. The energy storage module 170 can therefore be a rechargeable battery, a capacitor, a super capacitor, or any other suitable electrically energy storage device.

In this variation of the preferred flooring system 100, the energy storage module 170 preferably stores excess energy, captured by the preferred flooring system 100, that is beyond what is required to power the wireless transmitter 130 when transmitting a data packet. In this variation, the network 120 is preferably electrically coupled to the energy storage module 170 that is a printed or component-based battery or capacitor configured to store electrical energy. The wireless transceiver, which preferably includes the wireless transmitter 130, can subsequently access stored excess energy to reprogram internal settings and/or to modify firmware on the processor 150. For example, the processor 150 can be configured to wake the wireless transceiver to receive information at a given duty cycle such that a user can reprogram the wireless transceiver and/or the processor 150 by catching the wireless transceiver in an ON state in which the wireless transceiver is configured to receive the firmware update.

One variation of the preferred flooring system 100 further includes a radio-frequency identification (RFID) reader powered by at least one of the first and second currents and configured to extract identification information from a passive RFID tag in the near-field range by temporarily broadcasting an electromagnetic field. Generally, the RFID reader preferably siphons power from at least one energy device no, when a force is applied to the energy device 110, to temporarily output an electromagnetic field capable of powering adjacent passive RFID tags to output unique identification information. Alternatively, the RFID reader can be powered by a battery, capacitor, or other energy storage module that stores energy harvested by one or more energy device 110, wherein the RFID reader translates electrical energy from the energy storage module into electromagnetic radiation suitable to power an RFID tag. The RFID reader can power any suitable passive RFID tag, such as an RFID tag sewn into an article of clothing worn by a person, adhered to a housing of a cellular phone, installed in a shoe during manufacture, molded into a bicycle or passenger vehicle tire, incorporated into a sale tag on a retail item, and/or coupled or incorporated into any other item that may move or be transported across the flooring surface. When powered, a passive RFID tag preferably outputs a wireless signal that includes an identifier that is substantially unique to the particular RFID tag. For example, passive RFID tags can be serialized such that, when powered, a particular passive RFID tag transmits a unique serial number. Alternatively, when powered, a passive RFID tag can output a wireless signal that includes an identifier that is substantially unique to the type of object to which the RFID tag is coupled. For example, a first set of passive RFID tags with the same first output can be incorporated into shoes by a first manufacturer, and a second set of passive RFID tags with the same second output can be incorporated into shoes by a second manufacturer.

The RFID reader preferably collects identification information output by one or more passive RFID tags and communicates this information to the wireless transmitter 130, wherein wireless transmitter includes this identification information in a data packet that is subsequently transmitted. Alternatively, the RFID reader can communicate this information to the processor 150, wherein the processor 150 generates the data packet that includes this identification information, and wherein the wireless transmitter 130 transmits this data packet. This variation of the preferred flooring system that includes the RFID reader can therefore function to not only output signals corresponding to the application of forces applied to the flooring surface but can also output an identifier, identity, type, or characteristic of an object that applies a force to the flooring surface or one or more items proximal the object that applies the force to the flooring surface. Therefore, this variation can sustainably collect and transmit both identifying and location information of people or objects moving across the flooring surface by harvesting energy from forces applied by people or objects to the flooring surface.

### 2. Preferred Floor Tile

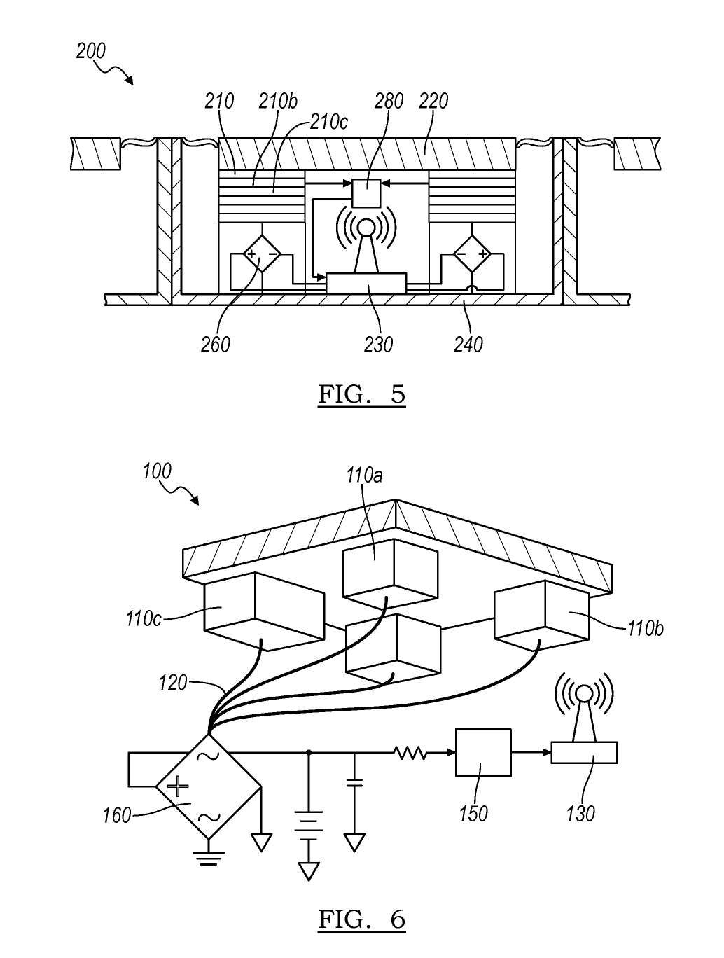

As shown in FIG. 5, a floor tile 200 of a preferred embodiment includes a flooring surface 220, a piezoelectric layer 210, a rectifier 260, and a wireless transmitter 230. The piezoelectric layer 210 is adjacent the flooring surface 220. The rectifier 260 is coupled to the piezoelectric layer 210 and is configured to direct positive and negative charge gradients of a strain cycle of the piezoelectric layer 210 to output current in response to a footstep on the flooring surface that deforms the piezoelectric layer. The wireless transmitter 230 is powered by current output from the rectifier 260 to transmit a data packet associated with the force applied to the flooring surface.

The preferred floor tile 200 is preferably a component of a floor system and harvests energy from forces applied thereto to power wireless transmission of data related to the applied forces. Generally, the preferred floor tile 200 preferably implements one or more energy devices that include one or more piezoelectric layers to harvest energy from persons or machinery imparting forces onto the preferred floor tile 200 while moving across the floor system. The preferred floor tile 200 is therefore preferably an independently-powered, standalone floor tile that is disconnected from any external electrical or chemical power source. The preferred floor tile 200 preferably instead harvests energy from mechanical vibrations, forces, pressures, impacts, etc. applied to the flooring surface 220, such as provided by humans or animals walking across the flooring surface 220 or by machinery or vehicles rolling across the flooring surface 220. Energy harvested by the preferred floor tile 200 preferably powers the wireless transmitter 230 and any other electronic device or circuitry within or connected to the preferred floor tile 200. The energy devices of the preferred flooring system 200 preferably double as sensors that detect a person, animal, or machine moving across the flooring surface 220, and the wireless transmitter 230 preferably transmits sensor signals from the energy device(s) to an external receiver. Therefore, the preferred floor tile 200 is preferably a self-contained, self-powered floor tile that collects and wirelessly transmits pedestrian and/or vehicle traffic data in real time.

The flooring surface 220 of the preferred floor tile 200 preferably defines an outer surface of the tile that is directly impacted by an object moving across the floor, and the flooring surface 220 preferably transmits the force, applied by the object, to the energy device. The flooring surface 220 preferably includes a textured, non-slip surface suitable for application in a commercial or residential building. Generally, the flooring surface 220 is preferably a standard floor, pathway, sidewalk, or road surface material, such as an embossed rubberized surface, linoleum, concrete, terrazzo, asphalt, granite, slate, ceramic tile, carpet, or wood. The flooring surface 220 is preferably supported by the piezoelectric layer 210 and is preferably substantially rigid such that a force applied thereto is efficiently transmitted into the piezoelectric layer 210. For example, the piezoelectric layer 210 can be applied across a large portion of the broad face of the preferred floor tile 200 opposite the outer surface of the flooring surface 220. Alternatively, the flooring surface 220 can be applied to a substrate that is substantially rigid and which transmits an applied force to the piezoelectric layer 210. The preferred floor tile 200 can alternatively include two or more energy devices that each include one or more piezoelectric layers, wherein the flooring surface 220 (or substrate) is suspended across two or more energy devices. For example, the flooring surface 220 can be a rubberized mat cemented to a square plywood substrate, wherein each corner of the substrate is supported by one of four energy devices. In this example, a housing can encase the energy devices, the wireless transmitter 230, and the back side of flooring surface. However, the flooring surface 220 can be supported by and transmit applied forces into the piezoelectric layer 210 in any other way.

As described above and shown in FIG. 5, one variation of the preferred floor tile 200 includes a housing that contains the piezoelectric layer 210, the rectifier 260, and the wireless transmitter 230. The housing 240 is preferably a rigid encasement that supports the piezoelectric layer 210 (or one or more energy devices) and includes an opening for the flooring surface 220 that does not inhibit displacement of the flooring surface 220 in the presence of an applied force. As shown in FIG. 5, the housing 240 can further include a flexible seal between the opening and the flooring surface 220 that seals the preferred floor tile 200 from moisture, dust, or other substances that may inhibit the function of the wireless transmitter 230, the piezoelectric layer 210, one or more energy devices, the rectifier 260, or any other component within the preferred floor tile 200. For example, the housing 240, seal, and flooring surface can cooperate to protect internal components with an Ingress Protection rating of 25 or greater.

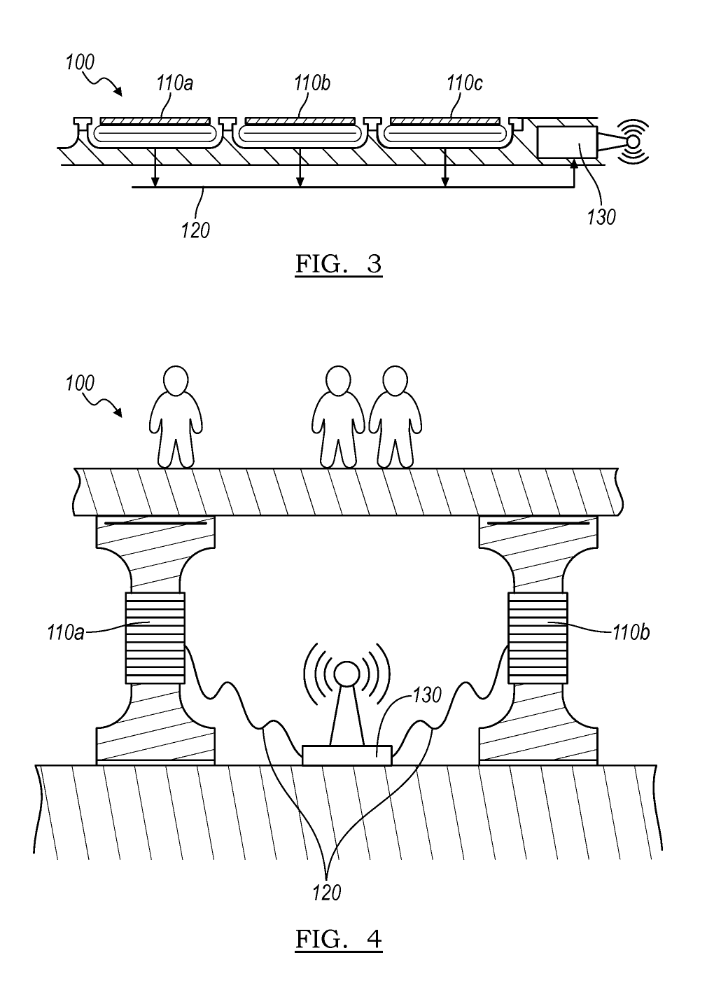

The housing 240 can also include external features that locate the preferred floor tile 200 relative to a set of similar floor tiles. In one example implementation shown in FIG. 3, the housing 240 couples to a floor mat opposite the flooring surface 220, wherein the floor mat defines a flooring substrate with an array of features that locate a set of floor tiles, including the preferred floor tile 200. In this example implementation, the floor mat is preferably arranged along a footpath with the set of floor tiles arranged on top of and located by the floor mat. The floor mat can further include conductive traces or cables that communicate digital signals and/or high-currents between the preferred floor tile 200 and other floor tiles in the set. In another example implementation, the housing 240 includes external features that directly couple to similar features on a housing of a similar adjacent floor tile. In this example implementation, the external features can include male and female features that prevent improper or reversed installation of a set of floor tiles. For example, the preferred floor tile 200 can send and/or receive a digital signal and/or a high-current to or from an adjacent floor tile, thus necessitating a common ground connection, a common data line, and/or a common high-current line, and the male and/or females features of the housing 240 of the preferred floor tile 200 can ensure that the ground, data, and/or power lines are properly connected with adjacent floor tiles. In a further example implementation, the preferred floor tile 200 includes a set of tabs by which the preferred floor tile 200 is screwed to a subfloor (e.g., a standard residential plywood subfloor). In this example implementation, the preferred floor tile 200 can be electrically coupled to an adjacent floor tile via a data and/or power cable. In another example implementation, the housing 240 is configured to be bonded to a subfloor, such as with a cement or glue. In this and other example implementations, the flooring surface 220 preferably extends to an edge of the housing 240 such that the preferred floor tile 200 can be arranged adjacent a similar floor tile without a substantial gap between flooring surfaces of adjacent floor tiles, thus eliminating a need for grout or other fillers between adjacent floor tiles.

The housing 240 is preferably a stamped or formed sheetmetal housing, though the housing 240 can be cast, machined, molded, formed, or manufactured in any other way in any metal, polymer, ceramic, or other suitable material.

The piezoelectric layer 210 of the preferred floor tile 200 is adjacent the flooring surface 220. The piezoelectric layer 210 preferably generates a voltage potential across a portion thereof when deformed by a footstep or other force applied to the flooring surface 220. The rectifier 260 then preferably outputs a current (e.g., a first current) that is driven by the voltage potential across the piezoelectric layer 210. The first current thus preferably powers the wireless transmitter 230 during transmission of the data packet that indicates the footstep or other force deformed the piezoelectric layer 210.

As described above, the piezoelectric layer 210 is preferably one piezoelectric layer in a stack of piezoelectric layers. The stack of piezoelectric layers preferably define an energy device that is arranged within the preferred floor tile 200, and the preferred floor tile 200 can include multiple similar energy devices. The rectifier 260 of the preferred floor tile 200 that includes a second piezoelectric layer is preferably further coupled to the second piezoelectric layer and directs positive and negative charge gradients of a strain cycle of the second piezoelectric layer to output current (e.g., a second current) in response to a footstep on the flooring surface that deforms the second piezoelectric layer. The second current preferably augments the first current to power the wireless transmitter 230 during transmission of the data packet, wherein the data packet include information indicative of the footstep or other force applied to the flooring surface 220 that deforms the energy device (or piezoelectric stack).

The energy device can also include an electrode arranged between the piezoelectric layer 210 and an adjacent (second) piezoelectric layer, wherein the electrode communicates current from the piezoelectric layers to the rectifier 260. The electrode preferably couples two or more piezoelectric layers to the rectifier 260 in parallel such that the magnitude of current output increases with an increasing number of piezoelectric layers. However, the electrode can alternatively couple two or more piezoelectric layers in series to increase peak voltage output with additional piezoelectric layers. In one example implementation, multiple electrodes in one energy device couple a set of piezoelectric layers in series and another set in parallel to meet a maximum voltage and current requirement for the one energy device. Electrodes in one energy device can be similarly arranged to meet a desired voltage and current requirement when a force of a particular magnitude is applied to the flooring surface 220.

As described above, the piezoelectric layer 210 is preferably a polyvinylidene fluoride piezoelectric layer in a stack of polyvinylidene fluoride piezoelectric layers in a single energy device. However, the piezoelectric layer 210 and any additional piezoelectric layers can be of any other material and arranged in the preferred floor tile 200 or in an energy device in any other way.

As described above, the piezoelectric layer 210 (or energy device) preferably generates a voltage gradient when compressed or deformed, and the rectifier 260 preferably cooperates with the piezoelectric layer 210 to output a current in a single direction. In one example implementation, the current from the piezoelectric layer 210 is rectified by the rectifier 260 and communicated directly to the wireless transmitter 230, wherein the wireless transmitter is powered on by the current, which triggers the wireless transmitter to transmit a unique identifier of the preferred floor tile 200 that indicates that a force has been applied to the flooring surface 220, such as in the form of a footstep. In another example implementation, the piezoelectric layer 210, the rectifier 260, a processor 250, a timer, or another component electrically arranged between the piezoelectric layer 210 and the wireless transmitter 230 can extract a sensor signal from the current output from the rectifier or from a voltage potential generated across a portion of the piezoelectric layer in the presence of an applied force. In this example implementation, the wireless transmitter 230 can be powered by a current signal separate and distinct from a sense signal. For example, the sense signal can include the time or magnitude of a force applied to the flooring surface 220. In this example implementation, a low-current (e.g., digital) form of the sense signal is preferably communicated to the wireless transmitter 230 and incorporated into the transmitted data packet, and a high-current form of the sense signal is preferably communicated from the rectifier 260 to power the wireless transmitter 230.

The rectifier 260 of the preferred floor tile 200 is coupled to the piezoelectric layer 210 and is configured to direct positive and negative charge gradients of a strain cycle of the piezoelectric layer 210 to output current when the piezoelectric layer 210 is deformed by the footstep on the flooring surface 220. As described above, the rectifier 260 preferably receives an alternating current from the piezoelectric layer 210(s) and converts the alternating current into a direct current (i.e. with current flowing in a single direction through the piezoelectric layer 210(s)). As described above, the rectifier 260 can be coupled to one or more piezoelectric layers or one or more energy devices within the preferred flooring tile. The rectifier 260 can be further coupled to one or more piezoelectric layers or one or more energy devices within an adjacent flooring tile. The rectifier 260 is preferably a bridge rectifying circuit, though the rectifier 260 can be any other suitable form or type or rectifier.

The wireless transmitter 230 of the preferred floor tile 200 is powered by current output from the rectifier 260 and is configured to transmit a data packet associated with the force applied to the flooring surface. As described above the current from the rectifier 260 is preferably communicated to the wireless transmitter 230, such as through a network that electrically couples multiple energy devices within the preferred floor tile 200 to the wireless transmitter 230 (e.g., through the rectifier 260). However, the wireless transmitter 230 can be electrically coupled to and powered by the piezoelectric layer 210(s) and/or energy device(s), via the rectifier 260, in any other way.

The wireless transmitter 230 preferably transmits the data packet that includes a unique identifier for the piezoelectric layer 210, a piezoelectric stack, an energy device, or a set of energy devices supporting one flooring surface 220 of one preferred floor tile 200. The unique identifier is preferably associated with a particular preferred floor tile 200 set in a known location such that signal received from the wireless transmitter 230 can be associated with a force or footstep at a known location that is the location of the particular preferred floor tile 200. In one example implementation, the wireless transmitter 230 is powered on by a current from the rectifier 260, and once powered on, the wireless transmitter 230 transmits a single data packet before shutting down in the presence of insufficient power. In this example implementation, the wireless transmitter 230 preferably resents once powered by a subsequent current from the rectifier 260 and transmits a subsequent data packet in response to a subsequent footstep or other force applied to the flooring surface 220. However, the data packet can include any additional or alternative information, such as the magnitude of an applied force or the time or timing of the applied force.

As described above, the wireless transmitter 230 can be a wireless Bluetooth module, though the wireless transmitter 230 can be any other suitable type of wireless communicate device.

One variation of the preferred floor tile 200 can also include a wireless receiver, which can receive data requests, system settings, system options, or any other signal or data that can be manipulated to control a data output or function of the preferred floor tile 200, as described above.

Another variation of the preferred floor tile 200 can further include a processor, which can analyze an output of the piezoelectric layer 210, an energy device, and/or the rectifier 260, as described above. The processor 250 is preferably powered by the current output from the rectifier 260 and preferably extracts data from the sense signal output by the piezoelectric layer 210. As described above, the processor 250 can determine the direction, speed, velocity, gait characteristic, mass, weight, type, etc. of an object moving across the flooring surface 220, any of which can be communicated to and transmitted by the wireless transmitter 230.

The preferred floor tile 200 that includes the processor 250 can function as a master floor tile, wherein sense signals from piezoelectric layers and/or energy devices in adjacent floor tiles can be communicated to the processor 250, wherein the processor 250 analyzes sense signals from the adjacent floor tiles, and/or wherein the processor 250 analyzes and tracks the data extracted from the sense signals. However, the processor 250 can function in any other way and can extract, track and/or analyze data pertaining to a sense signal in any other way.

As shown in FIG. 5, a further variation of the preferred floor tile 200 includes a sensor 280 that is powered by the current output from the rectifier 260. The sensor 280 can be a temperature sensor, pressure sensor, light sensor, moisture sensor, optical sensor or camera, accelerometer, sound sensor or microphone, or any other suitable type of sensor. The sensor 280 is also preferably electrically coupled to the wireless transmitter 230 that can further transmit a form of an output of the sensor 280. The sensor 280 can additionally or alternatively communicate an output to the processor 250 that can manipulate the sensor output to augment or inform an analysis of the sense signal from the piezoelectric layer 210. Additionally or alternatively, the processor 250 can interpret the output of the sensor 280 separate from the sense signal. For example, the sensor 280 can be an accelerometer that detects accelerations in the plane of the flooring surface 220, wherein the processor 250 correlates the magnitude of accelerations in the plane of the flooring surface 220 with motion of an object across the flooring surface 220 in a direction opposite the acceleration. The processor 250 can further correlate the accelerometer-based estimation of object motion direction with sense signals from one or more piezoelectric layers and/or energy devices. Additionally or alternatively, the processor 250 can modify a setting of the preferred floor tile 200 based upon a sensor output. For example, the sensor 280 that is a moisture sensor can output a signal correlating with excess moisture within the preferred floor tile 200, and the processor 250 can shutdown the preferred floor tile 200 and/or issue an alarm to the wireless transmitter 230 in response to the detected excess moisture. However, the preferred floor tile 200 can include any other type of sensor outputting any other type of signal to enable or control any other function of the preferred floor tile 200.

One variation of the preferred floor tile 200 further includes a RFID reader powered by current output from the rectifier 260 and configured to extract identification information from a passive RFID tag in the near-field range by temporarily broadcasting an electromagnetic field, as described above. Generally, the RFID reader preferably siphons power from the rectifier 260, when a force is applied to the flooring surface, to temporarily output an electromagnetic field capable of powering adjacent passive RFID tags to output unique identification information. The RFID reader can power any suitable passive RFID tag, such as an RFID tag described above. When powered, a passive RFID tag preferably outputs a wireless signal that includes an identifier that is substantially unique to the particular RFID tag and/or substantially unique to the type of object to which the RFID tag is coupled.

The RFID reader preferably collects identification information output by one or more passive RFID tags and communicates this information to the wireless transmitter 230, wherein wireless transmitter 230 includes this identification information in a data packet that is subsequently transmitted. Alternatively, the RFID reader can communicate this information to the processor 250, wherein the processor 250 generates the data packet that includes this identification information, and wherein the wireless transmitter 230 transmits this data packet. This variation of the preferred floor tile that includes the RFID reader can therefore function to not only output signals corresponding to the application of forces applied to the flooring surface but can also output information including an identity, type, or characteristic of an object that applies a force to the flooring surface and/or one or more items proximal an object that applies the force to the flooring surface. Therefore, this variation can sustainably collect and transmit both identifying and location information of people or objects moving across the floor tile 200 by harvesting energy from forces applied by people or objects to the flooring surface.

### 3. Applications

The preferred flooring system 100 described above can implement one or more preferred floor tiles 200 to capture and transmit data related to motion of objects across a flooring surface, wherein the preferred flooring system 100 requires no external electrical or chemical energy source and instead harvests all operating power from forces applied to the flooring surface by the objects. Alternatively, the preferred floor tile 200 can include the preferred flooring system 100 within a single housing, wherein multiple adjacent floor tiles define a floor, a footpath, a walkway, a sidewalk, stairs, a road, a driveway, a highway, or any other suitable ground or flooring surface.

Generally, the preferred flooring system 100 (or preferred floor tile 200) can be implemented in pedestrian and/or vehicular applications. For example, the preferred flooring system 100 can be applied to public parks, airport terminals, city sidewalks, pedestrian bridges, transportation platforms, public transit stations, corporate buildings, residential homes, offices, public interiors, public exteriors, exercise facilities, sports stadiums, stairs, dance clubs, recreational night spaces, conference centers, retail stores, university or corporate campuses, hospitals, hotels, casinos, museums, institutional campuses, high-security spaces (i.e. research or governmental facilities), or any other suitable pedestrian application. Similarly, the preferred flooring system 100 can be applied to city intersections, highways, bridges, parking lots, parking structures, city street parking spaces, bike lanes, ramps, high security commercial, research, and institutional campuses, distribution floors, manufacturing floors, or any other suitable vehicle-related application.

In one example application of the preferred flooring system 100 (or preferred floor tile 200), the preferred flooring system 100 is arranged over a pedestrian footpath, such as within an office building or along a sidewalk. In this example application, the preferred flooring system 100 is a standalone, self-powered floor system that tracks human traffic over the surface. The preferred flooring system 100 can thus control or influence interior lighting, such as by turning off lights when no foot traffic is detected for a threshold period of time and by turning lights back on when foot traffic is detected. However, the preferred flooring system 100 can control or influence any consumption of any other utility proximal or related to the preferred flooring system 100. Data collected by the preferred flooring system 100 can additionally or alternatively be used to track trends in pedestrian traffic over the flooring surface. For example, interior lights can be turned on according to an anticipated lighting need based on human traffic trends such that lights are turned on just before a first human is expected enter with a specified proximity of the preferred flooring system 100. Similarly, trend data from the preferred flooring system 100 can be indicative of building usage. For example, building usage can be correlated with life expectancy of certain building systems (e.g., elevators, carpet), fire code regulations (e.g., how many people are in the building at any given time), space requirement fulfillment (e.g., too much or too little space for a firm or company occupying the building), or utility requirements (e.g., water, electricity, heating, air conditioning). Similarly, building usage can be indicate with advertising effectiveness within the building (e.g., number of people who walk past an advertisement each day), the distribution of people throughout the building over time or at a particular time, or security risks within the building.

In another example application of the preferred flooring system 100 (or preferred floor tile 200), the preferred flooring system 100 is implemented in a vehicle (or truck) weigh station, wherein the preferred flooring system 100 harvests energy from a vehicle moving over the flooring system, and wherein the preferred flooring system 100 determines the mass or weight of the vehicle based upon the magnitude of the current or sense signal output by a piezoelectric layer, an energy device, and/or a rectifier.

In another example application of the preferred flooring system 100 (or preferred floor tile 200), the preferred flooring system 100 is implemented in a road surface. For example, the preferred flooring system 100 can control or influence the state of a traffic light based upon a detected force correlated with an approaching vehicle or can toggle road lighting based upon the presence of nearby road vehicles. The preferred flooring surface can additionally or alternatively track trends in road usage and/or traffic flow. For example, city planners can use traffic trends sensed by the preferred flooring system 100 to improve current traffic flow and/or to prepare for future traffic conditions. In another example, the preferred flooring system 100 can control or influence speed limits displayed on dynamic speed limit signs based upon current traffic conditions, such as based upon a comparison with historic traffic trends.

Similarly, in another example application, the preferred flooring system 100 can be implemented in parking lots or parking structures to monitor parking availability and/or parking needs at any instance in time or over a period of time (i.e. parking trends). In this example application, the preferred flooring system 100 can additionally control or influence parking rates. For example, parking rates can decrease when parking demand is low, and parking rates can increase when parking demand is high, wherein the preferred flooring system 100 is arranged on or below one or more parking spots and senses availability of the one or more parking spots. However, the preferred flooring system 100 and/or preferred floor tile 200 can be implemented in any other way, sense or extract any other data, and/or can control or influence any other function of any other pedestrian- or vehicle-related application.

In yet another example application of the preferred flooring system 100 (or preferred floor tile 200) that includes an RFID reader, the preferred flooring system 100 is tiled across a floor within a department store. In this example application, each saleable item in the store is labeled with a retail item price tag that includes a passive RFID tag configured to transmit a unique identifier when powered by a RFID reader. As a customer walks through the store and places items in a shopping cart, the customer's footsteps apply forces to the energy devices, which in turn power adjacent RFID readers. The RFID readers then generate temporary electromagnetic fields to power the RFID tags coupled to each item in the customer's shopping cart, and the RFID readers also receive the unique identifiers transmitted by each of the items. Wireless transmitters then transmit the unique identifiers, in the form of data packets, to a central server within the store, wherein the wireless transmitters are also powered by the customer's footsteps. The central server can then identify each object by accessing a database of unique item identifiers paired with item descriptions. The cart (or a shopping bag) user by the customer can also include a unique RFID tag such that the particular customer can be tracked and identified with his item selection as he moves through the store in which multiple other customers are shopping.

This example application can therefore be useful in tracking item selection through a store. Generally, the preferred flooring system 100 can repeatedly collect customer shopping information by polling the customer's cart and items placed therein (e.g., each time the customer steps on an energy device). This can enable the central server to track both the customer's motion and purchase progression during a single shopping experience. Rather than a receipt that is a descriptive of user shopping behavior at a single instance in time, this example application can collect time-based data pertaining to how a customer moves through a store, where he stops, when and how he back tracks, which items he picks up but does not buy, which items he places in his cart but ends up returning before checkout, his purchase sequence, how he is influenced by ads, how other items remind him to back track for another item (e.g., reminded to get bread when dropping peanut butter in his cart). This example application can therefore aid the store is adjusting floor or item layout, placing ads, determining which items customers like but do not buy (e.g., items picked up by users but not purchased, which may indicate that the item is too expensive), adjusting pricing, etc. to maximize customer purchases and/or improve user shopping experiences.

As a person skilled in the art will recognize from the previous detailed description and from the figures and claims, modifications and changes can be made to the preferred embodiments of the invention without departing from the scope of this invention as defined in the following claims.

We claim:

1. A flooring system comprising:
a first energy device configured for arrangement under a footpath and to output a first current in response to a force applied to the footpath;
a second energy device configured for arrangement under the footpath adjacent the first energy device and to output a second current in response to a force applied to the footpath;
a wireless transmitter; and
a network that communicates the first and second currents from the first and second energy devices to the wireless transmitter;
wherein the wireless transmitter is powered by at least one of the first and second currents to transmit a data packet associated with a force applied to the footpath.

2. The flooring system of claim 1, wherein the first energy device comprises a first floor tile and wherein the second energy device comprises a second floor tile.

3. The flooring system of claim 2, wherein the network comprises a mat that locates the first and second floor tiles along the footpath and further comprises a conductive conduit that electrically couples the first and second floor tiles to the wireless transmitter.

4. The flooring system of claim 3, wherein the wireless transmitter is arranged within the mat.

5. The flooring system of claim 2, wherein the network comprises a plurality of additional energy devices that comprise floor tiles, wherein the first energy device is in electrical contact with the second energy device, wherein the second energy device is in electrical contact with the network, and wherein the second energy device communicates the first current to the network.

6. The flooring system of claim 1, wherein each of the first and second energy devices comprises a piezoelectric energy harvester.

7. The flooring system of claim 6, wherein the first energy device comprises a rectifier that directs positive and negative charge gradients of a strain cycle of the first energy device to output the first current in response to a force applied to the footpath.

8. The flooring system of claim 1, wherein the wireless transmitter comprises a Bluetooth module.

9. The floor tile of claim 1, further comprising a radio-frequency identification reader powered by at least one of the first and second currents and configured to extract identification information from a passive radio-frequency identification tag in the near-field range by temporarily broadcasting an electromagnetic field, wherein the wireless transmitter transmits a data packet that comprises the identification information.

10. The flooring system of claim 1, further comprising a processor coupled to the wireless transmitter and powered by the first current to extract a first step signal from the first current.

11. The flooring system of claim 10, wherein the processor comprises an analog-to-digital converter that converts the first current from the first energy device into the first step signal that comprises a digital signal, wherein the wireless transmitter transmits the data packet that comprises a form of the digital signal.

12. The flooring system of claim 10, wherein the processor is further powered by the second current to extract a second step signal from the second current, wherein the processor estimates a gait characteristic of a user walking across the footpath based upon the first and second step signals.

13. The flooring system of claim 1, wherein the first energy device is arranged within a first access floor pedestal and wherein the second energy device is arranged within a second access floor pedestal.

14. The flooring system of claim 1, further comprising an energy storage module electrically coupled to the first and second energy devices, wherein the energy storage module stores energy harvested by the first and second energy devices.

15. The flooring system of claim 1, wherein the first energy device is configured to compress in response to a force applied to the footpath.

16. The flooring system of claim 1, wherein the wireless transmitter transmits the data packet that comprises a unique energy device identifier.

17. A floor tile comprising:
a flooring surface;
a piezoelectric layer adjacent the flooring;
a rectifier coupled to the piezoelectric layer and configured to direct positive and negative charge gradients of a strain cycle of the piezoelectric layer to output current in response to a footstep on the flooring surface that deforms the piezoelectric layer; and
a wireless transmitter powered by current output from the rectifier to transmit a data packet associated with the force applied to the flooring surface.

18. The floor tile of claim 17, further comprising a second piezoelectric layer adjacent the piezoelectric layer opposite the floor surface, wherein the rectifier is further coupled to the second piezoelectric layer and directs positive and negative charge gradients of a strain cycle of the second piezoelectric layer to output current in response to a footstep on the flooring surface that deforms the second piezoelectric layer.

19. The floor tile of claim 18, further comprising an electrode arranged between the piezoelectric layer and the second piezoelectric layer, wherein the electrode electrically couples the piezoelectric layer and the second piezoelectric layer to the rectifier.

20. The floor tile of claim 17, wherein the flooring surface defines a textured, non-slip surface.

21. The floor tile of claim 17, wherein the wireless transmitter comprises a wireless Bluetooth module.

22. The floor tile of claim 17, further comprising a housing that contains the piezoelectric layer, the rectifier, and the wireless transmitter in the form of a floor mat.

23. The floor tile of claim 17, further comprising a housing that contains the piezoelectric layer, the rectifier, and the wireless transmitter, wherein the housing couples to a floor array that locates the housing along the footpath.

24. The floor tile of claim 17, wherein the piezoelectric layer comprises a polyvinylidene fluoride piezoelectric layer.

25. The floor tile of claim 17, further comprising a sensor powered by current output from the rectifier.

26. The flooring system of claim 17, wherein the wireless transmitter transmits the data packet that comprises a unique floor tile identifier.

27. The flooring system of claim 26, wherein the wireless transmitter is further configured to receive a second output current from an adjacent floor tile, to be powered by the second output current, and to transmit a second data packet associated with a force applied to the adjacent floor tile, wherein the second data packet that comprises a floor tile identifier unique to the adjacent floor tile.

28. The floor tile of claim 17, further comprising a radio-frequency identification reader powered by current output from the rectifier and configured to extract identification information from a passive radio-frequency identification tag in the near-field range by temporarily broadcasting an electromagnetic field, wherein the wireless transmitter transmits a data packet that comprises the identification information.
